(19) United States
(12) Patent Application Publication
(10) Pub. No.: US 2007/0126593 A1
(43) Pub. Date: Jun. 7, 2007

(54) Massage apparatus having a remote controller

(75) Inventor: Simon Siu Man Nan, Richmond Hill (CA)

Correspondence Address: GREENSFELDER HEMKER & GALE PC, SUITE 2000, 10 SOUTH BROADWAY, ST LOUIS, MO, 63102, US

(73) Assignee: NANMA MANUFACTURING CO. LTD., Chai Wan (HK)

(21) Appl. No.: 11/295,981

(22) Filed: Dec. 7, 2005

(51) Int. Cl. A61H 1/00

(52) U.S. Cl. 340/825.69; 601/46

(57) ABSTRACT

A massage apparatus comprising a vibrator device in operative association with a remote controller for remote operation of the vibrator device is disclosed. The remote controller comprises a controller body having a control panel that remotely controls the operation of the vibrator device and a signal transmitter for transmitting a radio frequency signal having a predefined protocol to a signal receiver operatively associated with the vibrator device for controlling the operation of the vibrator device.

### FIELD

The present document relates to a massage apparatus having a remote controller.

### SUMMARY

In an embodiment, the massage apparatus comprises a vibrator device for providing a vibrating function, the vibrator device including a signal receiver adapted to receive a transmitted signal, and a remote controller operatively associated with the vibrator device, the remote controller including a signal transmitter for transmitting a signal to the signal receiver for operating the vibrating device.

In another embodiment, the remote controller is in operative association with a vibrator device comprising a controller body, the controller body including a control panel for remotely controlling the operation of the vibrator device, the controller body including a signal transmitter for transmitting a signal that controls the operation of the vibrator device.

In yet another embodiment, a method of remotely controlling a massage apparatus comprises the steps of:

a) providing a massage apparatus, the massage apparatus comprising a remote controller in operative association with a vibrator device for controlling the operation of the vibrator device, the remote controller comprising a signal transmitter for transmitting a signal and the vibrator device including a signal receiver for receiving said signal;

b) transmitting a signal from said signal transmitter to said signal receiver; and

c) receiving the signal by the signal receiver transmitted by the signal transmitter, wherein the signal defines a predefined protocol for controlling the operation of the vibrator device.

Implementations of the above embodiments may include one or more of the following features:

The remote controller is in remote operative association with the vibrator device.

The remote controller is in wireless communication with the vibrator device.

The transmitted signal is a radio frequency signal.

A resilient outer sleeve is adapted to engage said vibrator device.

The remote controller comprises a controller body with the controller body including an upper casing engaged to a lower casing.

The controller body is adapted to engage a battery cover.

A sealing element is engaged between said battery cover and said controller body.

The controller body includes a control panel with the control panel adapted to control the operation of the vibrator device.

The control panel remotely controls the operation of said vibrator device.

The control panel comprises an operational indicator for indicating that the remote controller is in operation.

The control panel comprises a push button, said push button providing a speed switch for controlling the operation of said vibrator device.

The control panel comprises an LED for indicating that the signal transmitter is transmitting the transmitted signal to the signal receiver.

The controller body defines a circular portion with the circular portion defining a battery chamber adapted to receive a battery therein.

The transmitted signal has a predefined protocol that controls the operation of said vibrator device.

The transmitted signal is a radio frequency signal having a predefined protocol that is transmitted to the vibrator device.

The predefined protocol controls the operation of said vibrator device.

Additional features will be set forth in the description which follows or will become apparent to those skilled in the art upon examination of the drawings and detailed description which follows.

### BRIEF DESCRIPTION OF THE DRAWINGS

FIG. 1 is a perspective view of the massage apparatus including a remote controller transmitting a signal to a vibrator device;

FIG. 2 is partial exploded perspective view of the remote controller; and

FIG. 3 is an exploded view of the remote controller.

Corresponding reference characters indicate corresponding elements among the view of the drawings.

### DETAILED DESCRIPTION

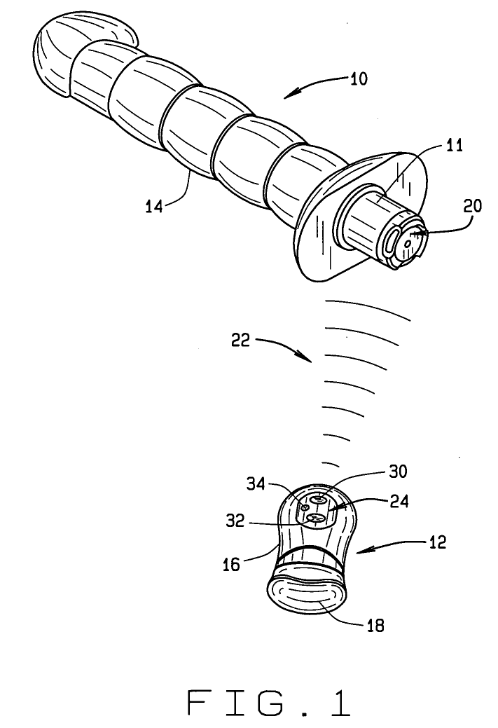

Referring to the drawings, an embodiment of the massage apparatus is illustrated and generally indicated as 10 in FIG. 1. The massage apparatus 10 may include a remote controller 12 in operative association with a vibrator device 11 for controlling the operation of device 11. The vibrator device 11 may include a signal receiver 20 adapted to receive a radio frequency signal 22 having a predefined protocol transmitted from the remote controller 12 in order to provide wireless control of the vibrator device 11 by the remote controller 12. In one embodiment, the signal receiver 20 may be retrofitted to an existing vibrator device 11 to operatively associate the vibrator device 11 with the remote controller 12, although in another embodiment the signal receiver 20 may be installed to the vibrator 11. In this manner, manually operating the vibrator device 11 directly is not required through use of the remote controller 12.

In one aspect, the vibrator device 11 may be engaged with a hollow, resilient outer sleeve 14 adapted to provide a vibration function when the vibrator device 11 is made operational by the remote controller 12. The resilient sleeve 14 may have a phallic, smooth, cylindrical, and/or segmented configuration, although other configurations are contemplated. In one embodiment, the vibrator device 11 may include a motor (not shown) that rotates a rod that spins an eccentric mass for providing the vibration function.

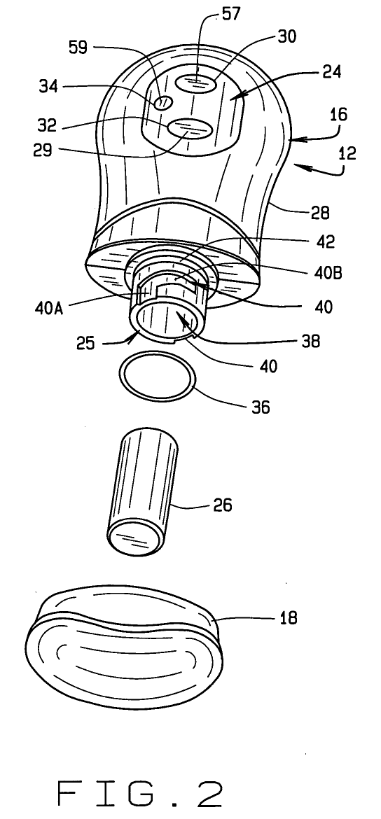

Referring to FIGS. 1 and 2, the remote controller 12 may include a controller body 16 having a removable battery cover 18 for encasing a battery 26 that provides a power source to remote controller 12. As shown, the controller body 16 may be a palm-sized hand-held device although other hand-held configurations are contemplated. The controller body 16 may define a circular portion 25 that extends outwardly along a center axis defined by the controller body 16.

The circular portion 25 may define an internal battery chamber 38 adapted to receive a battery 26 therein although it is contemplated that the battery chamber 38 may be adapted to receive a plurality of batteries 26. A shoulder seat 42 may be defined around the outer circumference of circular portion 25 that is adapted to engage a sealing element 36. The sealing element 36 provides a water-tight seal when the battery cover 18 is engaged to controller body 16. The circular portion 25 may also define opposing L-shaped slots 40 around the outer circumference thereof adapted to engage battery cover 18 to the controller body 16 as shall be discussed below. Each L-shaped slot 40 defines a vertical portion 40A in communication with a horizontal portion 40B adapted to engage the battery cover 18 to the controller body 16 as shall be discussed below.

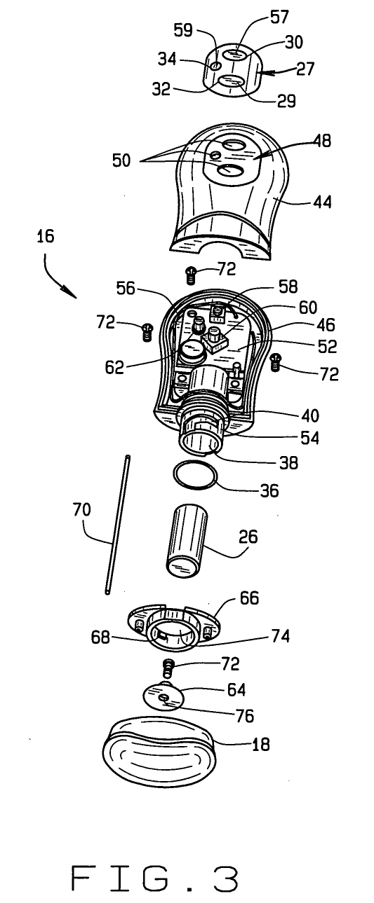

Referring to FIG. 3, the controller body 16 may include an upper casing 44 engaged to a lower casing 46 that houses the electrical components of the remote controller 12. The upper casing 44 may define a surface indentation 48 defining a plurality of holes 50. As further shown, the controller body 16 may include a control panel 24 (FIG. 2) engaged to the surface indentation 48 for controlling the operation of the vibrator device 11.

As further shown, the control panel 24 may include a flexible plastic sheet 27 having transparent portions 57 and 59 for providing visual and operational indications to the user and a flexible portion 29 for providing remote operational control of the vibrator device 11 with portions 29, 57 and 59 corresponding to respective holes 50.

In one embodiment, an LED 58 may extend through one of the holes 50 and is in operative association with a printed circuit board 52 disposed inside the controller body 16 and engaged by screws 72 to lower casing 46. The LED 58 may be viewed through transparent portion 57 and provides a visual indicator 30 that one or more radio frequency (RF) signals are being transmitted by the remote controller 12 to the vibrator device 11. In one embodiment, the frequency of the RF signals being transmitted may be 433 MHZ or 315 MHZ, although other frequencies are contemplated.

The printed circuit board 52 may further include a push button 60 that extends through one of the holes 50 and is in operative engagement with flexible portion 29 to provide a speed switch 32 that controls the operation of the vibrator device 11 when a user presses down against the flexible portion 29 and actuates push button 60. In one embodiment, when the vibrator device 11 is activated, the speed switch 32 may be actuated to provide the vibration function at low speed, while repeatedly actuating the speed switch 32 will provide a vibration function at medium speed and then high speed after each actuation. In addition, the printed circuit board 52 may include a light 62 that extends through another hole 50 and may be viewed through transparent portion 59 in order to provide an operational indicator 34 that visually indicates the operational state of the remote controller 12.

The battery cover 18 may include a flange cap 66 defining a central aperture 74 having opposing protrusions 68 along the inner circumference thereof which are adapted to engage the respective L-shaped slot 40 defined by the circular portion 54 when engaging the battery cover 18 to the controller body 16. A conductive plate 64 having a center hole 76 is engaged to a boss (not shown) defined by battery cover 18 using a screw 72. The printed circuit board 52 may be operatively engaged to a signal transmitter 56, such as an antenna, for transmitting the RF signals 22 to the signal receiver 20 of the vibrator device 11. In one embodiment the maximum operating range between the signal transmitter 56 and signal receiver 20 may be 4 meters, although other maximum operating ranges are contemplated.

When engaging the battery cover 18 to the controller body 16, the protrusions 68 are engaged to the respective opposing L-shaped slots 40 by first sliding each protrusion 68 along vertical portion 40A of a respective L-shaped slot 40 and then twisting the battery cover 18 relative to the controller body 16. This twisting action then slides the protrusion 68 along the horizontal portion 40B until the sealing element 36 is fully engaged such that a water-tight seal is established between the battery cover 18 and the controller body 16. A metallic sire 70 may be operatively engaged between an electric pole (not shown) of the printed circuit board 52 and the conductive plate 64 in order to provide an electric circuit for the remote controller 12.

It should be understood from the foregoing that, while particular embodiments have been illustrated and described, various modifications can be made thereto without departing from the spirit and scope of the invention as will be apparent to those skilled in the art. Such changes and modifications are within the scope and teaching of this invention as defined in the claims appended hereto.

What is claimed:

1. A massage apparatus comprising:
a vibrator device for providing a vibrating function, said vibrator device including a signal receiver adapted to receive a transmitted signal; and
a remote controller operatively associated with said vibrator device, said remote controller including a signal transmitter for transmitting said transmitted signal to said signal receiver for operating said vibrating device.

2. The massage apparatus according to claim 1, wherein said remote controller is in remote operative association with said vibrator device.

3. The massage apparatus according to claim 1, wherein said remote controller is in wireless communication with said vibrator device.

4. The massage apparatus according to claim 1, wherein said transmitted signal is a radio frequency signal.

5. The massage apparatus according to claim 1, wherein a resilient outer sleeve is adapted to engage said vibrator device.

6. The massage apparatus according to claim 1, wherein said remote controller comprises a controller body, said controller body including an upper casing engaged to a lower casing.

7. The massage apparatus according to claim 6, wherein said controller body is adapted to engage a battery cover.

8. The massage apparatus according to claim 7, wherein a sealing element is engaged between said battery cover and said controller body.

9. The massage apparatus according to claim 6, wherein said controller body includes a control panel, said control panel adapted to control the operation of said vibrator device.

10. The massage apparatus according to claim 6, wherein said control panel remotely controls the operation of said vibrator device.

11. The massage apparatus according to claim 9, wherein said control panel comprises an operational indicator for indicating that the remote controller is in operation.

12. The massage apparatus according to claim 9, wherein said control panel comprises a push button, said push button providing a speed switch for controlling the operation of said vibrator device.

13. The massage apparatus according to claim 9, wherein said control panel comprises an LED for indicating that said signal transmitter is transmitting said transmitted signal to said signal receiver.

14. The massage apparatus according to claim 6, wherein said controller body defines a circular portion, said circular portion defining a battery chamber adapted to receive a battery therein.

15. The massage apparatus according to claim 1, wherein said transmitted signal has a predefined protocol that controls the operation of said vibrator device.

16. A remote controller in operative association with a vibrator device comprising:
a controller body, said controller body including a control panel for remotely controlling the operation of the vibrator device, said controller body including a signal transmitter for transmitting a signal that controls the operation of said vibrator device.

17. The remote controller according to claim 16, wherein said signal transmitter is in wireless communication with the vibration device.

18. The remote controller according to claim 16, wherein said transmitted signal is a radio frequency signal having a predefined protocol that is transmitted to the vibrator device.

19. The remote controller according to claim 18, wherein said predefined protocol controls the operation of said vibrator device.

20. A method of remotely controlling a massage apparatus comprising the steps of:
a) providing a massage apparatus, said massage apparatus comprising a remote controller in operative association with a vibrator device for controlling the operation of said vibrator device, said remote controller comprising a signal transmitter for transmitting a signal and said vibrator device including a signal receiver for receiving said signal;
b) transmitting a signal from said signal transmitter to said signal receiver; and
c) receiving said signal by said signal receiver transmitted by said signal transmitter, wherein said signal defines a predefined protocol for controlling the operation of said vibrator device.
